(19) United States
(12) Patent Application Publication
(10) Pub. No.: US 2026/0141374 A1
(43) Pub. Date: May 21, 2026

(54) ACCESS PROVISIONS FOR VIRTUAL CARDS

(71) Applicant: GIESECKE+DEVRIENT EPAYMENTS GMBH, Munchen (DE)

(72) Inventor: Shawn RAMCHAND, Markham (CA)

(21) Appl. No.: 19/116,584

(22) PCT Filed: Sep. 27, 2023
(86) PCT No.: PCT/IB2023/000552

§ 371 Date: Mar. 28, 2025

(30) Foreign Application Priority Data
Sep. 29, 2022 (CA) 3177499

(51) Int. Cl. G06Q 20/34; G06Q 20/38; G06Q 20/40

(52) U.S. Cl. CPC G06Q 20/351; G06Q 20/3552; G06Q 20/3555; G06Q 20/3558; G06Q 20/3821; G06Q 20/4018

(57) ABSTRACT

A method and a card management system are for providing access to a virtual card, VC, the VC being issued to a user by a card issuer. The card management system includes an API management gateway and a virtual card, VC, handler. The VC handler is configured to receive through the API management gateway a request for VC credentials from the user; to fetch VC credentials; and to provide the VC credentials through the API management gateway to a card issuer app, for being pushed to the user for allowing a card non-present transaction on the card issuer app.

The present invention relates generally to virtual cards, and more specifically, to exemplary embodiments of an exemplary system and method for providing access to virtual cards.

### BACKGROUND OF THE INVENTION

Conventional payment systems are integrated with several card issuing entities, such as, banks and/or credit card companies. The card issuing entities can issue physical cards to customers. For instance, when such a card-holding customer desires to make a purchase online, the customer can provide to the merchant the account number and/or card number of either a physical debit card or credit card that was issued to him or her by a card issuing entity. However, signing up for a credit or debit card is typically a process that requires a substantial amount of time and is governed by regulatory requirements.

On the other hand, a digital card, virtual card or cloud card is an online hosted, digital virtual representation of any physical card, or any type of authorized credentials that can be used for eCommerce transactions. In contrast to a physical card, a virtual card does not require any physical representation in the first place as it is fully virtual and hosted online, reducing thus the time from the card request by the user to the card availability for the first transaction. Such a virtual card can emulate any kind of plastic card, and can thus support a so-called card not present (CNP) transaction. A CNP transaction is a payment card transaction made where the cardholder does not or cannot physically present the card for a merchant's visual examination at the time that an order is given and payment effected. It is most commonly used for payments made over telephone or Internet. Examples of such virtual card issuers may include ICICI Bank and Amazon Pay.

Such virtual cards are however restricted to a single card program, that is, they are coupled to a particular host banking system and card issuer, which are part of the transaction lifecycle, storage and security of cardholder data.

It is therefore desirable to provide a more flexible solution for accessing a virtual card.

### SUMMARY OF THE INVENTION

The present invention addresses the above object by the subject-matter covered by the independent claims. Preferred embodiments of the invention are defined in the dependent claims.

According to a first aspect of the present invention, there is provided a method for providing access to a virtual card, VC, by a card management system, the VC being issued to a user by a card issuer, the card management system comprising a virtual card handler, VC handler, and an API management gateway. The method comprises the steps of receiving at the VC handler a request for VC credentials, the request being sent by the user through the API management gateway; fetching by the VC handler, VC credentials; and providing the VC credentials through the API management gateway to a card issuer app, for being pushed to the user for allowing a card non-present transaction on the card issuer app.

According to a second aspect of the present invention, there is provided a card management system for providing access to a virtual card, VC, the VC being issued to a user by a card issuer, the card management system comprising an API management gateway, and a virtual card, VC, handler. The VC handler is configured to receive through the API management gateway a request for VC credentials from the user, to fetch VC credentials, and to provide the VC credentials through the API management gateway to a card issuer app, for being pushed to the user for allowing a card non-present transaction on the card issuer app.

The proposed method and system allows to create a digital or virtual representation of a physical card. In particular, once a card issuer is registered within the card management system, that is, an account is created, the virtual card credentials provided through the card issuer app to the user allow for a near-real time view of physical card details within banking applications, prior to the availability of the physical card. While the physical card is on the way, an exact digital representation is therefore available within the user's mobile app for online transactions. The user is thus provided with convenient, tangible and quick means for immediately performing CNP transactions both online and in-store.

Within this specification, a card issuer refers to any bank and/or credit card company issuing physical credit/payment cards to customers. Further, the card issuer may provide to the user a web/mobile banking app (also referred as card issuer app) with secure channels for login.

The card management system is preferably hosted at the card personalization bureau, which is the instance producing and providing the physical credit card to banks and/or credit card company.

A VC request is a personalized/payment credential received at the card management system. Payment credential can be card information (physical or virtual factor), wearable, mobile credential. The payment credentials are those in scope for personalization and fulfilment related. A VC request can be received as part of the personalization order file, portal user interface,
ordering of information systems and/or API and other methods for requests.

In some embodiments of the present invention, the VC request comprises a request ID and authentication information. Preferably, the method further comprises storing in a private cloud of the card management system the request ID and the authentication information. The authentication information may indicate the form of authentication, such as, for instance, a token based authentication that generates an encrypted security token that is unique to each virtual card.

This allows linking the user to the card (through the card issuer app and the card management system) providing thus for a more flexible solution over conventional single card programs.

In some embodiments of the present invention, the method comprises further fetching VC credentials by retrieving a cardholder record corresponding to the request ID from a VC cloud storage. In a further step, authentication between the card issuer and the VC handler may be performed using the authentication information stored with the request ID. Subsequently, upon successfully performed authentication, the VC credentials are provided to the card issuer app.

In this way it is ensured that only users allowed to login into a card issuer app have access to the virtual card. The user can thus access a virtual card using existing issuer's login authentication into issuer app.

Preferably, the authentication information comprises a session key between the VC issuer and the VC handler.

In some embodiments of the present invention, prior to receiving the request for VC credentials, the VC issuer is registered with the card management system.

In some embodiments of the present invention, a request for card personalization is received at the card management system from the card issuer. The request comprises data uniquely identifying each cardholder record of a plurality of cardholder records for users requesting access to virtual cards issued by the card issuer. For each cardholder record card personalization is performed.

In some embodiments of the present invention, the method comprises receiving from the card issuer a card verification value for each personalized cardholder record.

Preferably, the card verification value is a static card verification value, CVV. Preferably, the card verification value is a dynamic card verification value, CVV.

Supporting a dynamic CVV provides for a more secure solution for the issuer app, reducing thus credit/payment card fraud.

In some embodiments of the present invention, card personalization is performed by creating a subscription or cardholder record comprising VC credentials for each cardholder record based at least on the received data, in particular, request ID and authentication information, and the received card verification value, wherein the subscription record is stored in a database. The database may be located in a private cloud of the VC handler.

Preferably, the VC data credentials comprises at least one of a primary account number (PAN), an expiration date, and a card verification value.

In some embodiments of the present invention, the card management system comprises a digital content output manager, DCOM. The DCOM may be configured to create digital assets, in particular, card images, for each cardholder record and to store for each cardholder record the digital assets, preferably in the corresponding cardholder record together with the VC credentials.

In some embodiments of the present invention, the DCOM is configured to provide the digital assets to the VC handler upon receiving a VC image provision request from the issuer card app.

In some embodiments of the present invention, the card management system is configured for being accessed as a Software Development Kit through an API library integrated within a user's mobile banking application.

This provides an efficient way for cardholders to perform CNP transactions with reference to virtual cards.

In some embodiments of the present invention, the card management system is configured to delete the cardholder records after a pre-set time period after the creation of the cardholder records has elapsed.

This allows provision of a temporary virtual credit card with a limited-day subscription. A temporary VC can be made available for instance for 30-45 days, at which point the VC details are purged from the VC handler. If the issuer wishes for VC to extend past the pre-set time-limit, data lifecycle management, consent and other considerations in data storage may be implemented to hold data past the temporary period.

It has to be noted that all the devices, elements, units and means described in the present application could be implemented in software or hardware elements or combination thereof. All steps which are performed by the various entities described in the present application as well as the described functionalities are intended to mean that the respective entity is adapted to or configured to perform the respective steps and functionalities.

Further aspects, features and advantages of the present invention will become apparent to those of ordinary skills in the art upon reviewing the following detailed description of preferred embodiments and variants of the present invention in conjunction with the accompanying figures.

### BRIEF DESCRIPTION OF THE DRAWINGS

Reference will now be made to the accompanying figures, in which:

FIG. 1 shows a schematic diagram illustrating the process flow of a customer/user applying for a physical card and receiving access to a virtual card, according to an embodiment of the invention;

FIG. 2 shows a structural diagram of a system according to an embodiment of the invention;

FIG. 3 shows a schematic representation of a card management system for providing VC services according to a further embodiment of the invention;

FIG. 4 shows a flowchart for a method for registering a card issuer and for providing access to a virtual card to a user according to an embodiment of the invention;

FIG. 5 shows a schematic representation of the process from card personalization to virtual card output according to an embodiment of the invention;

FIG. 6 shows a schematic diagram illustrating the process flow of performing a card-not-present (CNP) transaction using virtual card credentials according to an embodiment of the invention;

FIG. 7 shows a signal diagram of a CNP transaction according to an embodiment of the present invention; and

FIG. 8 shows schematic representations of virtual card credentials as provided to the user according to an embodiment of the invention.

### DETAILED DESCRIPTION

Detailed explanations of the present invention are given below with reference to attached drawings that illustrate specific embodiment examples of the present invention. These embodiments are described in sufficient detail to enable those skilled in the art to practice the invention. It is to be understood that the various embodiments of the present invention, although different, are not necessarily mutually exclusive. For example, a particular feature, structure, or characteristic described herein in connection with one embodiment may be implemented within other embodiments without departing from the scope of the present invention. In addition, it is to be understood that the position or arrangement of individual elements within each disclosed embodiment may be modified without departing from the scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

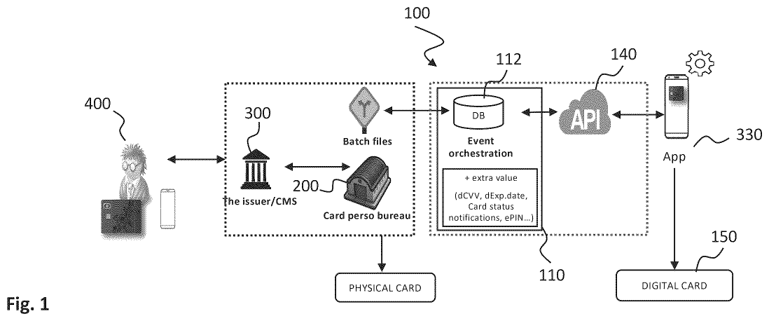

FIG. 1 shows a schematic diagram illustrating the process flow of a customer/user applying for a physical card and receiving access to a virtual card, according to an embodiment of the invention.

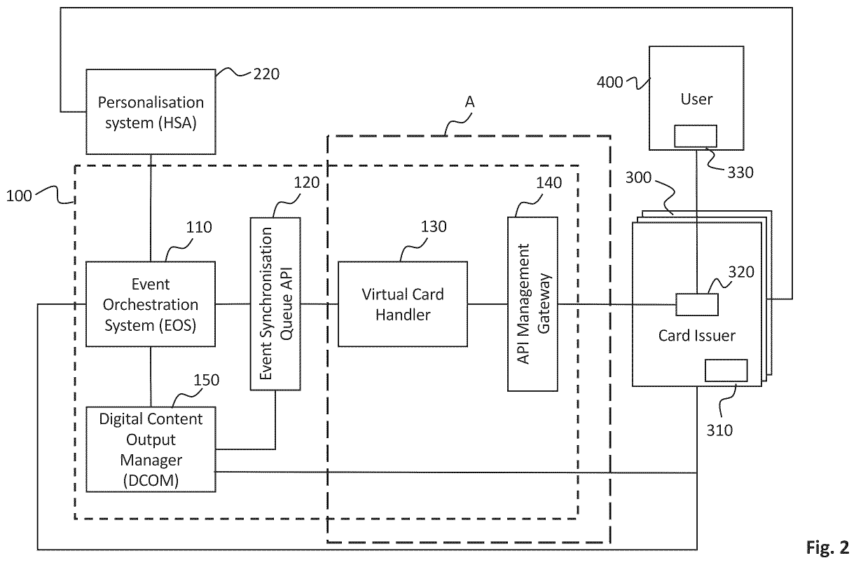

With reference to FIG. 1, a customer or user 400 is applying for a (physical) credit card with a credit card issuer 300. A corresponding virtual card 150 is created and access to virtual card credentials are provided to the user prior to the physical card's arrival. This is performed by a card management system 100 and its components, which are illustrated in FIG. 2.

The card management system 100 provides digital and physical orchestration, by creating a digital or virtual representation of the physical card and supporting CNP transactions for the user 400 before he/she receives the physical card.

Particularly, the card management system 100 functions as an intermediate entity between the card issuer 300 and a mobile banking application 330 (also referred to as issuer app), through which the user 400 can access the virtual card 150 for performing CNP transactions.

The card management system 100 may be integrated or provided within the mobile banking app 330 via a complete SDK (Software Development Kit), which contains a library of APIs 140. The APIs may be customized to the issuer request, during the onboarding of the virtual card, or in response to individual requests in form of API calls. In any case, upon receiving a request (for instance from the card issuer 300 during onboarding or via API calls from the card issuer app 330) to provide virtual card data credentials (VC credentials for short), the card management system 100 fetches the VC credentials from a database 112 and provide them to the card issuer app 330 to being pushed, and thus displayed and made accessible to the user 400, preferably via the mobile banking app or any other suitable app running on a user device (e.g., a mobile phone or desktop computer).

Virtual card VC credentials (also referred to as data credentials) may comprise a PAN, a static or dynamic expiration date, static or dynamic CVV, ePIN, card status, among other card-related data.

The Primary Account Number (PAN) uniquely identifies a payment card and is generated when an account is opened with the card issuer.

The card verification number (CVV) is a three-digit code located on the back of credit and debit cards. A CVV is considered a static value, as it is imprinted on the card. In contrast a dynamic card verification value (dCVV) is a new code created periodically, thus increasing the security of payment card transactions. A dynamic CVV can be provided by G+D, Visa, MasterCard or any scheme that offers the API services described throughout this specification.

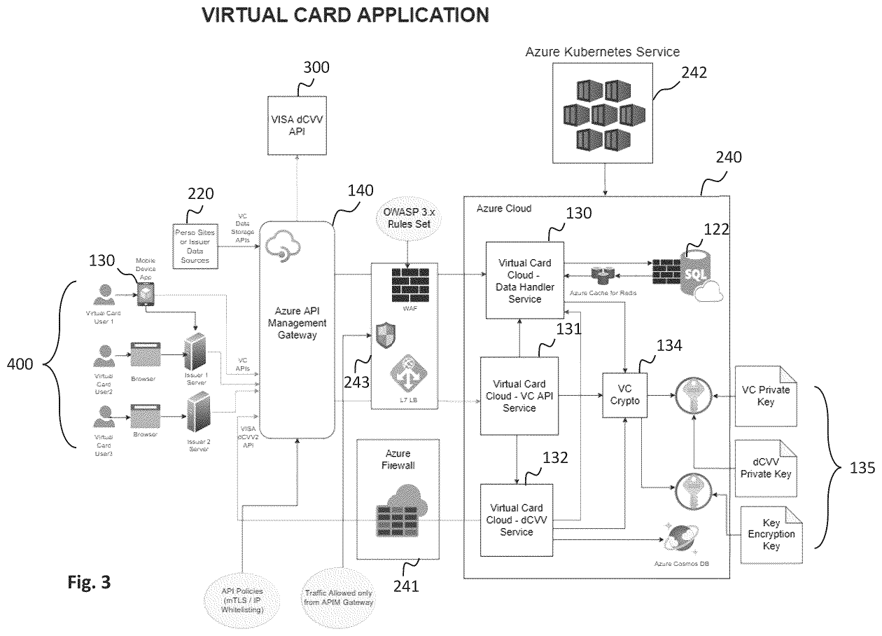

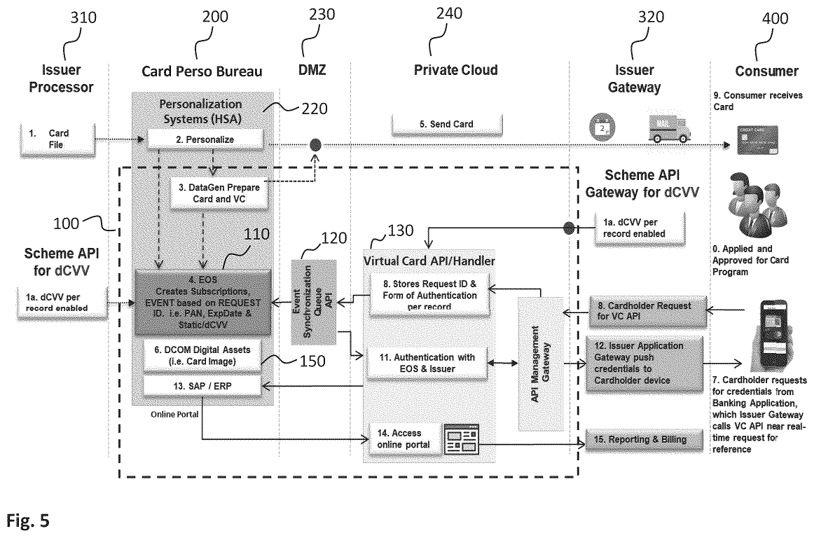

VC data credentials may be provided to the card management system 100 during onboarding, that is, during registration of a card issuer with the card management system respectively the card personalization bureau 200, a process which will be described further down with reference to FIGS. 3, 5 and 5.

FIG. 2 shows a structural diagram of the card management system 100 and the other entities the card management system is interacting with. A preferred implementation of block A is illustrated in FIG. 3.

With reference to FIG. 2 and FIG. 3, the request for VC credentials is received at the VC handler 130 from the user 400 via the API management gateway 140. The VC request comprises a request ID and authentication information, and is stored in a private cloud 240. The VC handler 130 fetches the VC data credentials and provides them to the API management gateway 140 to a card issuer app 330, for being pushed to the user 400 for allowing a card non-present transaction on the card issuer app 330.

In addition to the VC handler 130 the card management system 100 may comprise several components for providing VC services, such as VC API service 131, dCVV service 132, VC encryption services 134, the latter using a plurality of security leys 135. Preferably, access to the VC cloud 240 from the API management gateway is provided through a firewall 241. A rule set 243 is used to specify access rule.

In one embodiment the VC data credentials are provided to the VC handler directly by the card issuer 300 through the API management gateway 140. The VC credentials are stored in the VC handler, preferably in a cloud database 112. With other words, cardholder data goes through API management gateway 140 for being stored and fetched for reference. The cardholder data is stored in such a way that it can be referenced through the request ID received at the VC. By storing the VC credentials in a VC handler private database 112, compliance with the Payment Card Industry Data Security Standard, PCI-DSS, is achieved.

In an embodiment the card management system 100 may comprise in addition to the VC handler 140 and the API management gateway 140 further an event orchestrations system (EOS) 110.

The event orchestration system (EOS) is responsible for managing all cardholder records of registered card issuers but also for managing the plurality of requests received from users through card issuers applications (including non-registered card issuers). Through the availability of information stored at the EOS, data analytics can be implemented both at the card personalization bureau as well as at the card issuers. EOS allows further for information flexibility on multi-services support to data issuance.

In an alternative or in addition to the VC handler 130 receiving directly the VC credentials from the card issuer, in a preferred embodiment, the VC credentials can be managed by the event orchestrations system (EOS) 110 of the card management system 100. The EOS 110 creates and stores in the database 112 a plurality of cardholder records for each of the plurality of registered card issuers. Each cardholder record may comprise VC credentials for each user approved to receive a physical card by a card issuer. The EOS can be regarded as a data lake collecting all cardholders'data and supporting input file and direct file creation. All data may be available via API requests from an issuer gateway 330 via the API management gateway 140.

The VC handler 130 may be communicating with the EOS 110 through an API, as for instance the event synchronization queue API 120. VC requests received at the EOS from the VC handler are recorded in the EOS as EOS requests or events. The event synchronization queue API 120 may be hosted within a DMZ 230, adding thus an additional layer of security.

Preferably, a VC request comprises a request ID and authentication information, which upon being received at the EOS are recorded and stored as an EOS event. The authentication information may comprise a session key between the card issuer app 330 and the VC handler 130. Other authentication forms, such as two-factor-authentication via pin and/or biometrics may be employed as well.

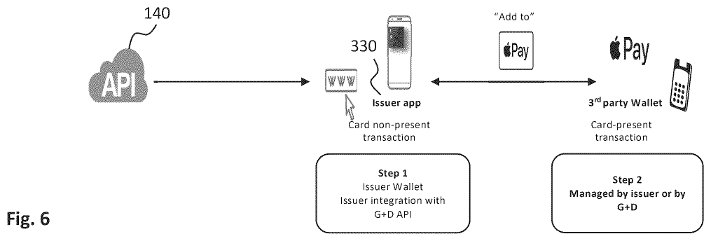

The request ID may be obtained at the issuer app 330 through the issuer server 310 sending a request to a server of the card personalization bureau 200, as will be described in connection with FIG. 6 further below.

The VC handler 130 is further responsible for obtaining from the EOS 110 the VC credentials and for providing the VC credentials to the card issuer app 330, for being pushed to the user 400. The VC credentials are provided to the user 400 preferably via the API management gateway 140 and the issuer gateway 320.

The digital content output manager (DCOM) 150 is responsible for creating and managing further digital assets, in particular visual data, to be output to the issuer app 330. This may include creating a card image of the virtual card and providing the card image via the issuer gateway 320 to be displayed within the issuer app 330 at the user 400.

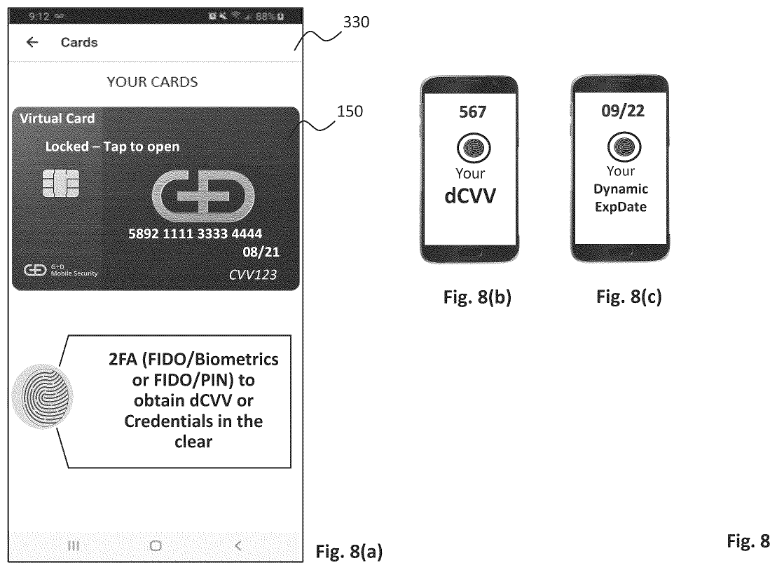

An example of an image of a virtual card 150 displayed within the issuer app 330 is depicted in FIG. 8(a). The card image may be overlaid with the VC credentials received upon request from the VC handler. For instance, the virtual card 150 in FIG. 8(a) shows the PAN, expiration date and a static CVV. Instead of the static CVV, a dynamic CVV can be provided by the card management system, and displayed in the issuer app 330 as illustrated in FIG. 8(b). The dynamic expiration date may be displayed as well, preferably upon request, as depicted in FIG. 8(c).

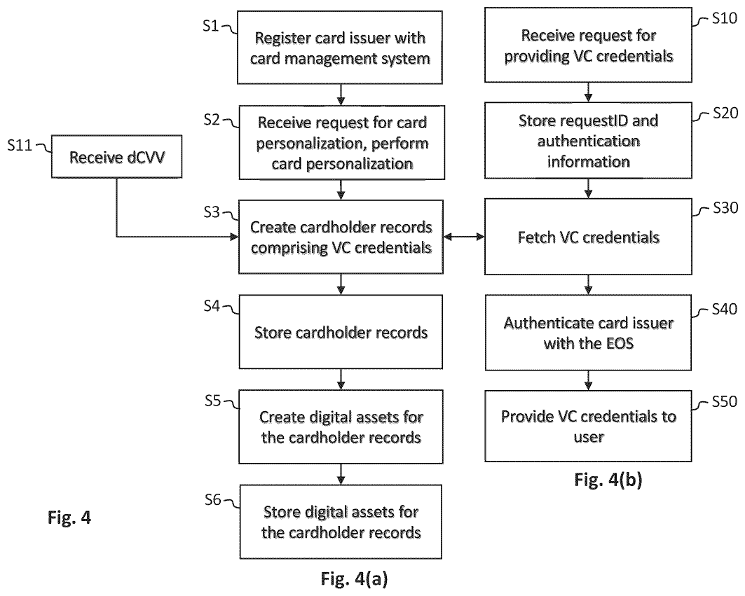

The functionality of the card management system 100 is presented in the following with reference to FIGS. 4 and 5.

FIG. 4 shows flowcharts for a method for registering a card issuer and for providing access to a virtual card to a user according to an embodiment of the invention. The method comprises two parts, namely FIG. 4(a) shows the steps for onboarding or registering a card issuer, while FIG. 4(b) shows the steps performed by the card management system for virtual card output, that is, for providing to a user access to the virtual card. Steps S1 and S2 are not necessarily performed by the card management system. These are preliminary steps, usually handled at the card personalization bureau 200 through the personalization system HSA 220. Alternatively, the HSA may be integrated within the card management system 100.

The entire process from card personalization to virtual card output according to an embodiment of the invention is schematically illustrated in FIG. 5. Main steps depicted in FIG. 5 corresponds to the steps depicted in FIG. 4, whereas FIG. 5 shows also additional or optional steps not illustrated in FIG. 4.

With reference to FIG. 4(a) in a preliminary first step S1 a card issuer 300 is registered with the card personalization bureau 200 through the intermediary of the personalization system HSA 220. This allows the card issuer 300 to be set-up with the card personalization bureau 200, to enable approved cardholders card fulfillment and personalization delivery.

That is, the card issuer 300 is able to submit card order requests for personalization and fulfilment with additional required data per each unique cardholder record for delivery (step S2 in FIG. 4; step “1” in FIG. 5). This step may in addition include step 3 depicted in FIG. 5, for preparing a personalized physical card. The personalization data is pushed to the EOS 110 to be stored thereon as VC or personalization credentials. For this, cardholder records are created in step S3 and stored in the database 112 of the EOS 110 in step S3.

In parallel or independently of steps S1 and S2, the card issuer 300 (respectively its processor 310) may sent a dCVV (dynamic card verification value) in step S11 (corresponds to step “1a” in FIG. 4). This may occur periodically, or every time a new dCVV is created. With other words, while a static CVV may be received with the request for registration, a dynamic CVV may be received every time a new value is created at the card issuer.

Based on the received CVV (or dCVV) and the card personalization data, a cardholder subscription or record is created in step S3, and stored in the database 112 in step S4. The cardholder record contains thus the VC credentials uniquely identifying a virtual card for a user which has been approved for receiving the corresponding physical card. This step is preferably implemented by the event orchestration system (EOS) 110.

In a further, possibly optional step, S5, additional information, such as digital assets, may be created for each cardholder record, and stored in step S6. The digital assets may be stored in the database 112 together with the cardholder records belonging to the same virtual card and may be uniquely identified for instance by a record ID.

The flow chart in FIG. 4(b) depicts the steps performed by the card management system 100 for providing a virtual card 150 to a user 400 upon receiving in step S10 a request for VC credentials.

In step S20 the request ID and the authentication information received within the VC request in step S10 is extracted from the VC request and stored. The authentication information may indicate the form of authentication, such as, for instance, a token based authentication that generates an encrypted security token that is unique to each virtual card. The request ID and the authentication information may be stored in a private cloud (reference numeral 240 in FIG. 4) of the card management system 100.

The EOS 110 may record the received VC request as an EOS request or event, uniquely identified by the request ID. Preferably, the EOS 110 receives the VC requests through an API, such as for instance the event synchronization queue API 120 in FIG. 4. Using a queue allows for processing all VC requests in a well-defined order.

In step S30 the VC credentials corresponding to the request ID are fetched from the database 112, and after authenticating the EOS 110 with the requesting card issuer 300 in step S40 (step 11 in FIG. 4), provided to the card issuer app 330 to be pushed (step 12 in FIG. 4) to the user 400 for being displayed through the mobile banking app at the user's device.

After the user has received the VC credentials he/she can perform a CNP transaction.

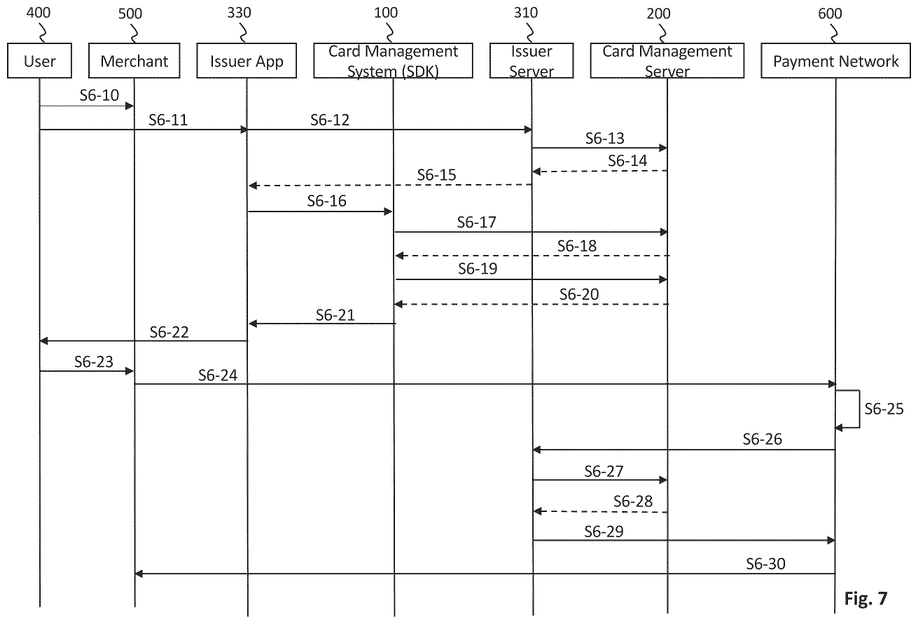

This process is illustrated in FIG. 6 in a generic way with implementation and signaling details between the entities involved in the CNP transaction shown in FIG. 7.

With reference to FIG. 6, the user may use the VC credentials provided through the issuer app 330 to add this payment method to an existing account such as for instance Apple Pay.

Alternatively, the user may perform a CNP transaction with a merchant as depicted in FIG. 7.

In a step S6-10 the user 400 enters the credit card details at a merchant 500. This may be performed by phone, internet or physically through a card payment device at the merchant. In step S6-11 the user 400 logs into his issuer app 330, and requests VC credentials.

The VC credentials are obtained from the card management system 100, which is being accessed as a SDK from the issuer app, through a series of steps S6-12 to S6-22, which correspond to the steps described above in connection with FIG. 4(b) and FIG. 5.

In particular:
In step S6-12 a request for VC credentials is sent from the issuer app 330 over the issuer server 310 to the card management server 200 (step S6-13). These steps correspond to step S10 in FIG. 4(a) and step 8 in FIG. 5. The card management server may be provided by the card personalization bureau 200 of FIG. 1.
A request ID is generated at the card management server 200 and provided to the issuer app 330 (step S6-15) via the issuer server 310.
Through the issuer app 330 the card management system 100 is provided with the request ID, step S6-16.
The request is authenticated in steps S6-17 and S6-18.
Authentication steps S6-17 to S6-19 verifies issuer app's identity as well as validity of the request.
In step S6-21 the VC credentials are provided by the card management system 100 to the issuer app 330, to be shown to the user 400 in step S6-22.
In step S6-23 the user can input the received VC credentials into the merchant's payment system.
In step S6-24 the merchant 500 requests over the payment network 600 transaction to be processed (step S6-25).
In steps S6-26 to S6-29 the payment network 600 performs authorization and validation of the transaction with the card issuer server 310, and
If authorization and validation were successful, the merchant is presented with the transaction confirmation in step S6-30.

The aspects and embodiments described herein allow to create a near real-time virtual view of physical card details within banking applications prior to the arrival of the physical card. By instant delivery of card credentials, such as PAN, expiration data, static/dynamic CVV, both the card issuer and the user/cardholder are provided with efficient and secure means for performing card-not-present transactions.

Further benefits include:
Cardholders are encouraged to download and access banking application to reference VCs.
Cardholders are encouraged to perform online transactions prior to the card arriving.
Two subscription options are provided for the card issuers, a permanent subscription and a temporary one, by configuring the card management system to delete the cardholder records after a pre-set time period after their creation has elapsed.
By leveraging card issuers'existing secure login details, an efficient and secure method for accessing VC credentials is provided.
The authentication capabilities within the VC handler can be customized to different form of authentications, allowing thus provision of further layer of authentication (e.g., biometric scan, two factor authentication).

In the foregoing specification, the invention has been described with reference to specific embodiments thereof. It will, however, be evident that various modifications and changes may be made thereto without departing from the broader scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

1.-15. (canceled)

16. A method for providing access to a virtual card, VC, by a card management system, the VC being issued to a user by a card issuer, the card management system comprising a virtual card handler, VC handler, and an API management gateway, the method comprising:
receiving at the VC handler a request for VC credentials, the request being sent by the user through the API management gateway;
fetching by the VC handler VC credentials; and
providing the VC credentials through the API management gateway to a card issuer app, for being pushed to the user for allowing a card non-present transaction on the card issuer app.

17. The method according to claim 16, wherein the VC request comprises a request ID and authentication information, the method further comprising storing in a private cloud of the card management system the request ID and the authentication information.

18. The method according to claim 17, further comprising:
fetching VC credentials by retrieving a cardholder record corresponding to the request ID from a VC cloud storage;
performing authentication between the card issuer and the VC handler; and
upon successful authentication, providing the VC credentials to the card issuer app.

19. The method according to claim 17, wherein the authentication information comprises a session key between the card issuer app and the VC handler.

20. The method according to claim 16, further comprising prior to receiving the request for VC credentials from the card issuer app, registering the card issuer with the card management system.

21. The method according to claim 16, further comprising receiving from the card issuer a request for card personalization, the request comprising data uniquely identifying each cardholder record of a plurality of cardholder records for users requesting access to virtual cards, and performing card personalization for each cardholder record.

22. The method according to claim 20, further comprising receiving from the card issuer a card verification value for each personalized cardholder record.

23. The method of claim 22, wherein the card verification value is a dynamic card verification value, dCVV, or a static card verification value, CVV.

24. The method according to claim 20, wherein the step of card personalization is performed by creating a subscription or cardholder record comprising VC credentials for each cardholder records based at least on the received data and the received card verification value, and storing the subscription record in a database, preferably located in the VC handler private cloud.

25. The method according to claim 20, comprising:
creating by a digital content output manager, DCOM, of the card management system, digital assets, in particular, card images, for each cardholder record; and
storing for each cardholder record the digital assets in the corresponding cardholder record, preferably together with the VC credentials.

26. The method according to claim 25, comprising:
providing the digital assets to the VC handler, upon receiving a VC image provision request from the issuer card app.

27. A card management system for providing access to a virtual card, VC, the VC being issued to a user by a card issuer, the card management system comprising:
an API management gateway; and
a virtual card, VC, handler, configured to:
receive through the API management gateway a request for VC credentials from the user;
fetch VC credentials; and
provide the VC credentials through the API management gateway to a card issuer app, for being pushed to the user for allowing a card non-present transaction on the card issuer app

28. The card management system according to claim 27, further comprising an event orchestration system, EOS, configured to create and store a plurality of cardholder records for each of a plurality of card issuers, each cardholder record comprising VC credentials for each user approved to receive a physical card by a card issuer.

29. The card management system according to claim 28, configured to receive from a personalization system, HAS, of a card personalization bureau personalization information for registered card issuers,
wherein the card management system is configured to store cardholder records and to provide VC credentials only for registered card issuers.

30. The card management system according to claim 27, further comprising a digital content output manager, DCOM, configured to create digital assets, in particular, card images, for each cardholder record, to store for each cardholder record the digital assets, preferably in the corresponding cardholder record together with the VC credentials, and to provide the digital assets to the VC handler, upon receiving a VC image provision request from the issuer card app.
